(19) United States
(12) Patent Application Publication
(10) Pub. No.: US 2024/0078788 A1
(43) Pub. Date: Mar. 7, 2024

(54) ANALYZING DIGITAL CONTENT TO DETERMINE UNINTENDED INTERPRETATIONS

(71) Applicant: International Business Machines Corporation, Armonk, NY (US)

(72) Inventors: Pierre C. BERLANDIER, San Diego, CA (US); Jean POMMIER, Cupertino, CA (US)

(21) Appl. No.: 17/929,305

(22) Filed: Sep. 1, 2022

(51) Int. Cl. G06V 10/764

(52) U.S. Cl. CPC G06V 10/764

(57) ABSTRACT

A collaborative analysis system may obtain digital content. The collaborative analysis system may analyze the digital content using first components of the collaborative analysis system. The collaborative analysis system may determine a plurality of types of information regarding the digital content based on analyzing the digital content using the first components. The collaborative analysis system may analyze the plurality of types of information using a second component of the collaborative analysis system. The collaborative analysis system may determine one or more unintended interpretations of the digital content based on analyzing the plurality of types of information. The collaborative analysis system may cause the digital content to be modified to prevent the one or more unintended interpretations. To perform the analysis, the components may utilize machine learning models, optical character recognition, fuzzy logic, inductive reasoning, reasoning with ontologies, knowledge graphs, geometric predicates and/or spatial reasoning.

### BACKGROUND

The present invention relates to analyzing digital content, and more specifically, to analyzing digital content to determine unintended interpretations.

Digital content (e.g., image data) may be generated using one or more computing devices. The digital content may be stored in a memory device. The one or more computing devices may cause the digital content to be published. For example, the one or more computing devices may enable other devices to access the digital content stored in the memory device. Alternatively, the one or more computing devices may provide the digital content to the other devices. The other devices may include one or more server devices and/or one or more user devices.

The digital content may be generated to convey a message to users associated with the one or more server devices and/or associated with one or more user devices. For example, the digital content may be generated to convey an intended interpretation (e.g., an intended meaning) to the users. In some instances, one or more users may provide (e.g., using the one or more user devices) an indication that the digital content is conveying an unintended interpretation (e.g., an unintended meaning). The unintended interpretation may be negative, inappropriate, insensitive, offensive, and/or otherwise undesirable. Accordingly, the one or more computing devices may take remedial actions regarding the digital content that has been published.

The remedial actions may include deleting the digital content from the memory device, provide notifications to the other devices that the digital content has been deleted, and/or causing the other devices to be reconfigured based on the digital content being deleted from the memory device, among other examples. In this regard, the remedial actions may consume computing resources, network resources, and/or storage resources, among other examples, in order to delete the digital content, to provide the notifications to the other devices, and/or to reconfigure the other devices, among other examples. Accordingly, there is a need to determine an unintended meaning of the digital content prior to the digital content becoming accessible to the other devices.

### SUMMARY

In some implementations, a computer-implemented method performed by a collaborative analysis system, the computer-implemented comprising obtaining digital content from a data structure; analyzing the digital content using first components of the collaborative analysis system, wherein each component, of the first components, utilizes a respective machine learning model to analyze the digital content; determining a plurality of types of information regarding the digital content based on analyzing the digital content using the first components; storing the plurality of types of information in the data structure; analyzing the plurality of types of information using a second component of the collaborative analysis system, wherein the second component utilizes a respective machine learning model to analyze the plurality of types of information; determining one or more unintended interpretations of the digital content based on analyzing the plurality of types of information; and performing an action to cause the digital content to be modified to prevent the one or more unintended interpretations.

In some implementations, analyzing the digital content comprises determining, by a component of the first components, whether to analyze the digital content using one or more types of information of the plurality of types of information; analyzing, by the component, the digital content using the one or more types of information based on determining to analyze the digital content using one or more types of information; and generating, by the component, an additional type of information based on analyzing, by the component, the digital content using the one or more types of information.

An advantage of determining the one or more unintended interpretations prior to the digital content being published (e.g., being provided to user devices for visual output and/or for audio output) is preserving computing resources, network resources, and/or storage resources, among other examples, that would have otherwise been consumed to delete the digital content, to provide the notifications to the other devices, and/or to reconfigure the other devices, among other examples, among other examples. An advantage of determining the one or more unintended interpretations prior to the digital content being published is ensuring that an intended message of the digital content is accurately communicated. Another advantage of determining the one or more unintended interpretations prior to the digital content being published is ensuring that a brand reputation, associated with the digital content, is preserved. Another advantage of determining the one or more unintended interpretations prior to the digital content is providing notifications to a device of a creator (or an owner) of the digital content. The notifications may enable the creator (or the owner) to determine different meanings of the digital content before the digital content is produced.

In some implementations, a computer program product for determining unintended interpretations of content includes one or more computer readable storage media, and program instructions collectively stored on the one or more computer readable storage media, the program instructions comprising: program instructions to analyze digital content using first components of a collaborative analysis system; program instructions to determine a plurality of types of information regarding the digital content based on analyzing the digital content using the first components; program instructions to analyze the plurality of types of information using a second component of the collaborative analysis system; program instructions to determine one or more unintended interpretations of the digital content based on analyzing the plurality of types of information; and program instructions to provide information regarding the one or more unintended interpretations to a device.

An advantage of determining the one or more unintended interpretations prior to the digital content being published (e.g., being provided to user devices for visual output and/or for audio output) is preserving computing resources, network resources, and/or storage resources, among other examples, that would have otherwise been consumed to delete the digital content, to provide the notifications to the other devices, and/or to reconfigure the other devices, among other examples, among other examples.

In some implementations, a system comprising: one or more devices configured to: analyze information regarding digital content using first components of the system; determine a plurality of types of information regarding the digital content based on analyzing the information regarding the digital content using the first components; analyze the plurality of types of information using a second component of the system, wherein the second component utilizes a respective machine learning model to analyze the plurality of types of information; determine one or more unintended interpretations of the digital content based on analyzing the plurality of types of information; and provide information regarding the one or more unintended interpretations to a device.

When providing the information regarding the one or more unintended interpretations, the one or more devices may be configured to determine a first measure of confidence associated with the first group of unintended interpretations; determine a second measure of confidence associated with the second group of unintended interpretations; rank the first information and the second information based on the first measure of confidence and the second measure of confidence; and provide the first information and the second information based on ranking the first information and the second information.

An advantage of ranking the unintended interpretations is to identify a more probable unintended interpretation. By identifying the more probable unintended interpretation, the collaborative analysis system may preserve computing resources, network resources, and/or storage resources, among other examples that would have been used to determine changes to the digital content to address each of the unintended interpretations.

### BRIEF DESCRIPTION OF THE DRAWINGS

FIGS. 1A-1E are diagrams of an example implementation described herein.

FIG. 2 is a diagram of an example environment in which systems and/or methods described herein may be implemented.

FIG. 3 is a diagram of an example computing environment in which systems and/or methods described herein may be implemented.

FIG. 4 is a diagram of example components of one or more devices of FIG. 2.

FIG. 5 is a flowchart of an example process relating to managing an operation of a data center based on localized weather conditions predicted for the data center.

### DETAILED DESCRIPTION

The following detailed description of example implementations refers to the accompanying drawings. The same reference numbers in different drawings may identify the same or similar elements.

Implementations described herein are directed to analyzing digital content to determine an unintended interpretation of digital content. The term “determine” may be used to refer to “identify.” The phrase “unintended interpretation” may be used to refer to an unintended meaning of the digital content, an unintended message conveyed by the digital content, or a potential misinterpretation of the digital content. In some instances, the unintended interpretation may be undesirable, inappropriate, insensitive, and/or offensive, among other examples. The digital content may include text, image data of an image, video data of a video, and/or audio data of an audio.

In some examples, the collaborative analysis system may obtain the digital content from a knowledge base data structure. Alternatively, the collaborative analysis system may obtain the digital content from a user device. The collaborative analysis system may analyze the digital content using first components of the collaborative analysis system. The first components may include software agents that utilize machine learning models to analyze the digital content and/or information regarding the digital content. The first components may include an image recognition component, a natural language processing (NLP) component, a layout component, and/or a semiotic component, among other examples.

As an example, the image recognition component may utilize a first machine learning model to detect items identified in the digital content and positions (or locations) of the items in the digital content. The items may include objects, words, animals, and/or persons, among other examples. The image recognition component may generate first type of information regarding the items and the positions.

The NLP component may utilize a second machine learning model to analyze the first type of information to determine a meaning associated with the words, determine a concept associated with the words, and/or determine a relationship between the words. The NLP component may generate a second type of information regarding the meaning, the concept, and/or the relationship.

The layout component may utilize a third machine learning model to analyze the first type of information and/or the second type of information to determine one or more groups of items based on the items identified by the digital content and based on the positions of the items. For example, the layout component may determine geometric associations between the items and/or geometric oppositions between the items. The layout component may generate a third type of information regarding the geometric associations and/or the geometric oppositions.

The semiotic component may utilize a fourth machine learning model to analyze the first type of information, the second type of information, and/or the third type of information to determine a semiotic meaning associated with objects identified by the digital content. The semiotic component may generate a fourth type of information regarding the semiotic meaning. The first components may store, in the knowledge base, the first type of information, the second type of information, the third type of information, and so on. The different types of information may be data elements. While the first components have been described as analyzing information in a particular sequence, in some implementations, the first components may analyze information in the knowledge base data structure in a different sequence. For example, the sequence may be opportunistic and dynamic, driven by the information that a first component finds in the knowledge base data structure. In some implementations, two or more of the first components may analyze the information in the knowledge base data structure simultaneously. The information may include the digital content and/or information derived by one or more of the first components. In other words, a first component may derive information based on the digital content and/or information derived from one or more other first components. For example, a first component which is focused on deriving information based on metaphors can use the information that a peach was recognized in the image by the image recognition component in order to derive new metaphorical information associated to the peach.

The collaborative analysis system may include one or more second components configured to analyze the different types of information to determine one or more unintended interpretations of the digital content. As an example, the one or more second components may include one or more software agents that utilize one or more machine learning models to analyze the different types of information. For example, a polysemy component may utilize a fifth machine learning model to determine one or more unintended interpretations associated with the objects, the meaning of the words, the concept associated with the words, the relationship between the words, the geometric associations, the geometric oppositions, and/or the semiotic meaning, among other examples.

As explained herein, the collaborative analysis system may simulate a collaborative analysis, of the digital content, involving the first components and the one or more second components. For example, one component of the first components may generate information based on analyzing the digital content and store the information in the knowledge base data structure. In some instances, based on determining whether to analyze the information, another component of the first components may generate additional information based on analyzing the information and may store the additional information in the knowledge base data structure.

In this regard, the first components may collaborate and contribute to at least the areas of linguistic findings, concept associations, scene understanding, text recognition, speech recognition, and image recognition. The collaborative analysis, of the digital content, may enable the one or more second components (of the collaborative analysis system) to detect polysemy associated with the digital content based on analyzing information contributed by the first components. As an example, the digital content may be generated to convey a message of a fashionable hairstyle (e.g., a clean shaven haircut). Based on the collaborative analysis of the digital content, the collaborative analysis system may determine that the digital content may convey the unintended interpretations of a military personnel and/or a survivor of a disease.

The collaborative analysis system may determine the one or more unintended interpretations prior to the digital content being published (e.g., prior to the unintended interpretation being provided to one or more user devices). An advantage of determining the one or more unintended interpretations prior to the digital content being provided to the user devices (e.g., for visual output and/or for audio output) is that the collaborative analysis system may preserve computing resources, network resources, and/or storage resources, among other examples, in order to delete the digital content that has been published, to provide the notifications to devices that have accessed the digital content, and/or to reconfigure the devices, among other examples.

In some implementations, the collaborative analysis system may provide information regarding the one or more unintended interpretations to enable the digital content to be modified. For example, the collaborative analysis system may aggregate the one or more unintended interpretations as aggregated unintended interpretations and provide the aggregate unintended interpretations for review. The collaborative analysis system may provide information for all unintended interpretations. In some situations, the collaborative analysis system may rank the unintended interpretations based on a measure of confidence associated with each of the unintended interpretations. For example, the collaborative analysis system may rank the unintended interpretations from more probable to less probable.

An advantage of ranking the unintended interpretations is to identify a more probable unintended interpretation. By identifying the more probable unintended interpretation, the collaborative analysis system may preserve computing resources, network resources, and/or storage resources, among other examples that would have been used to determine changes to the digital content to address each of the unintended interpretations. While the collaborative analysis system has been described with respect to particular components, in some implementations, the collaborative analysis system may include additional or fewer components. Additionally, the first components and the second components have been described as utilizing machine learning models, in some implementations, the first components and the second components may utilize reasoning approaches such as first order logic/inference (e.g., geometric predicates and/or spatial reasoning), fuzzy logic, inductive reasoning, reasoning with ontologies, knowledge graphs, optical character recognition, among other examples.

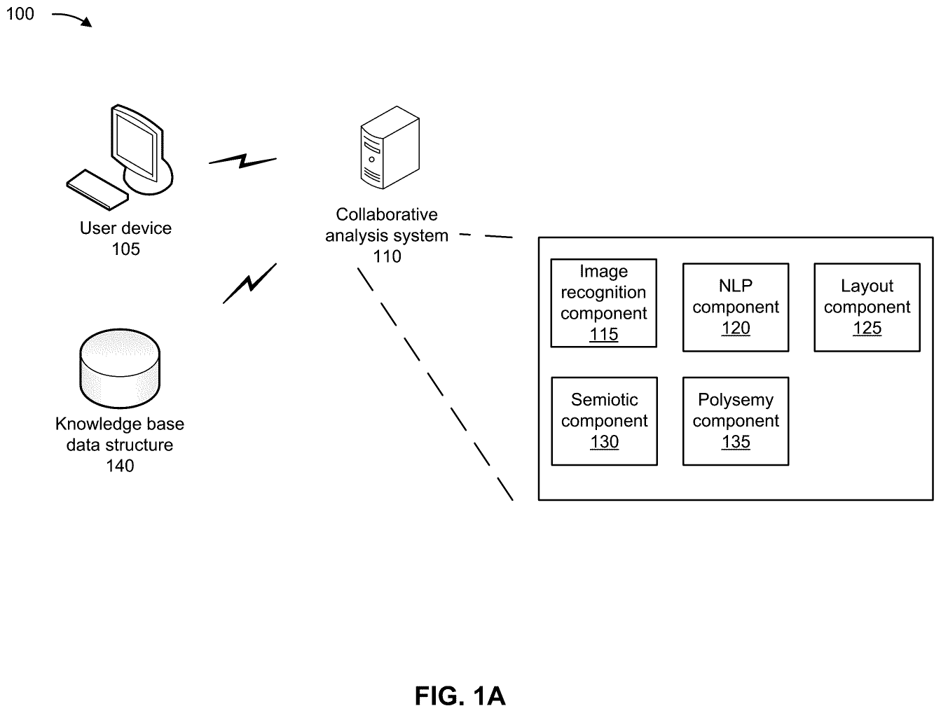

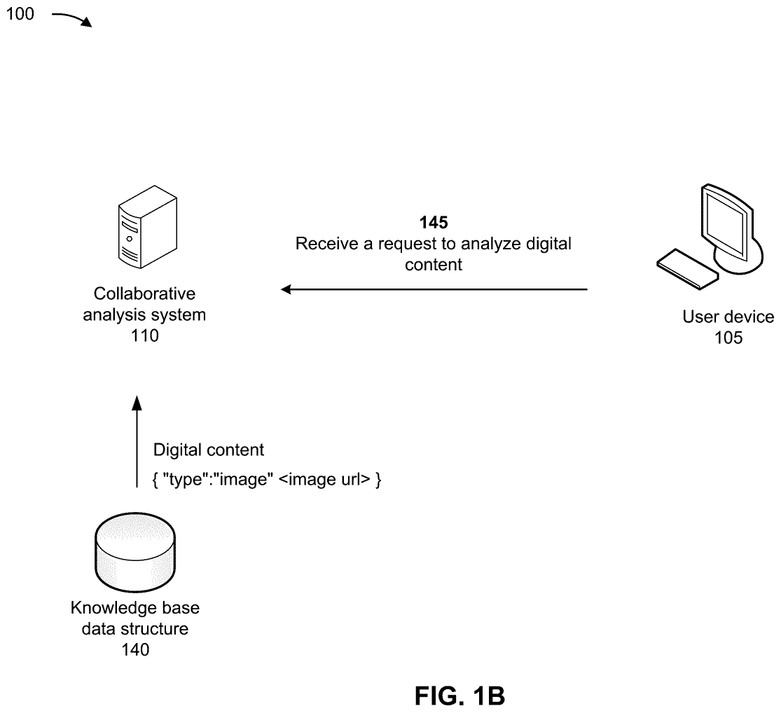

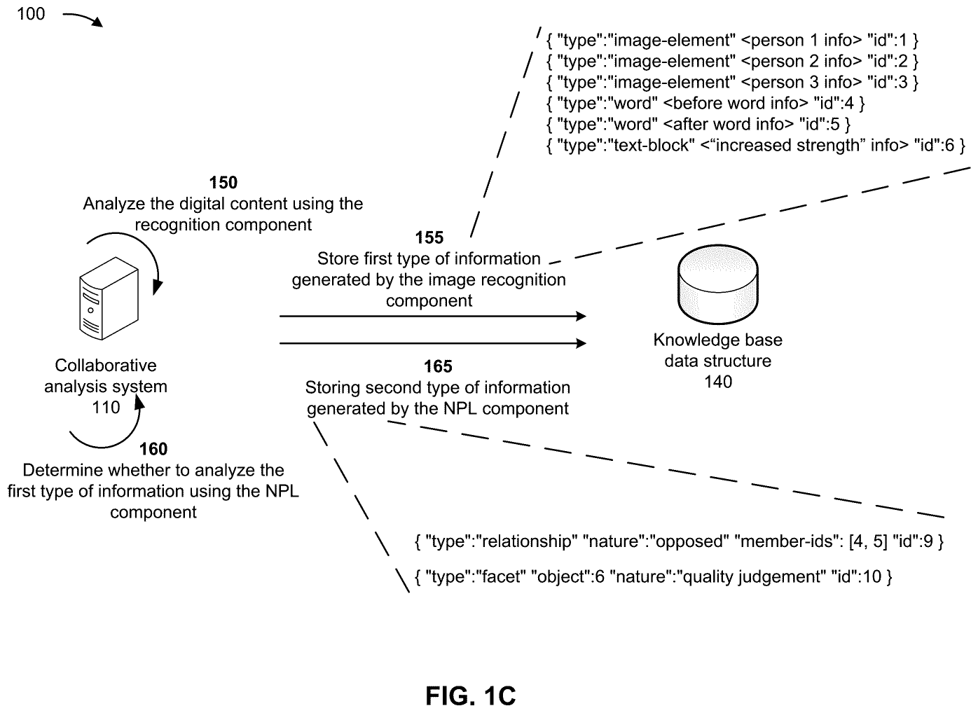

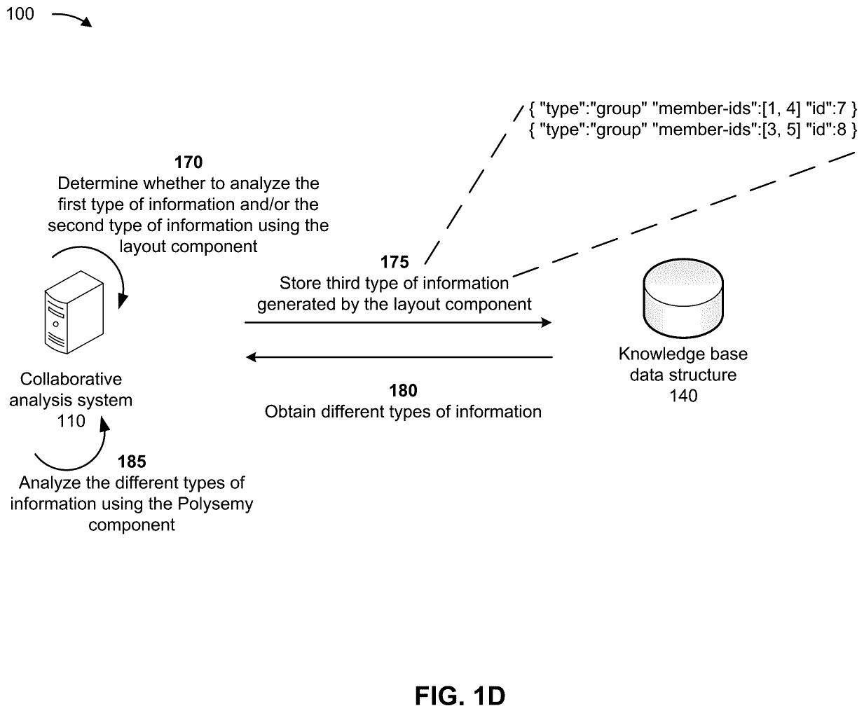

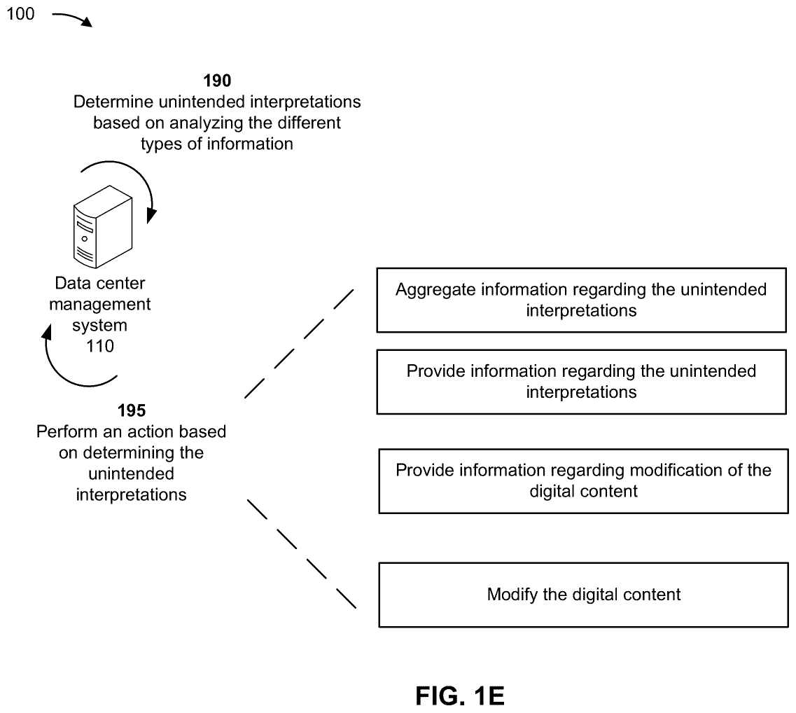

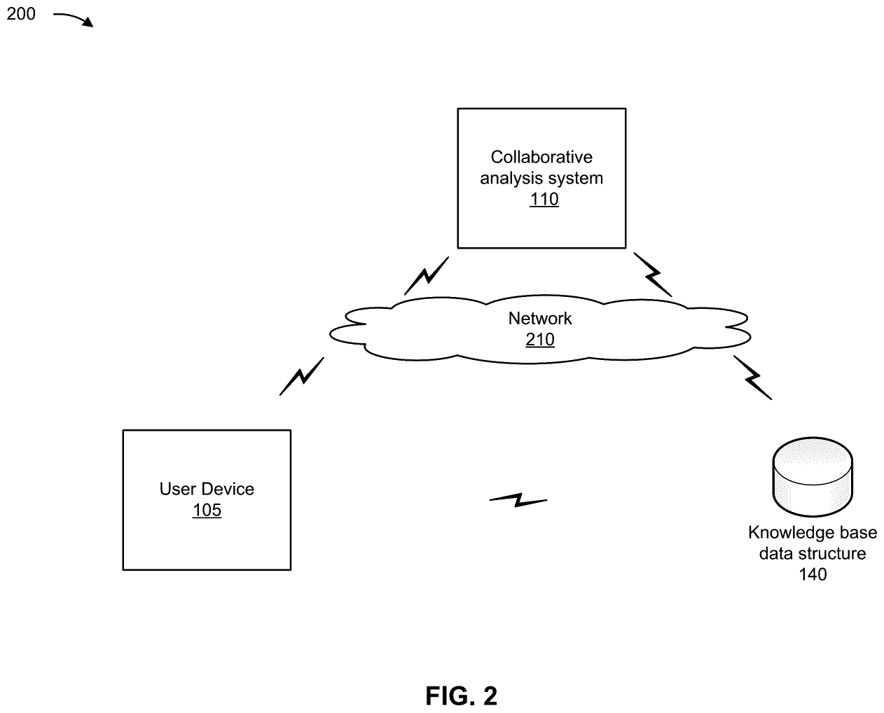

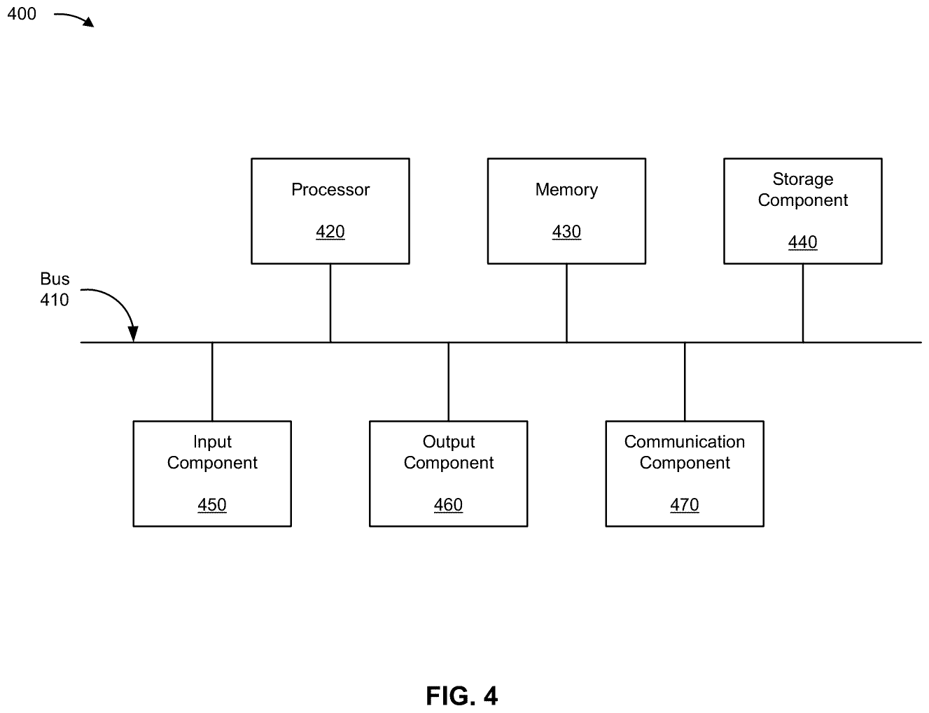

FIGS. 1A-1E are diagrams of an example implementation 100 described herein. As shown in FIGS. 1A-1E, example implementation 100 includes a user device 105, a collaborative analysis system 110, and a knowledge base data structure 140. These devices are described in more detail below in connection with FIG. 2 and FIG. 4.

User device 105 may include one or more devices capable of receiving, generating, storing, processing, and/or providing information associated with determining one or more unintended interpretations of digital content, as described elsewhere herein. In some examples, user device 105 may provide the digital content to collaborative analysis system 110 and/or provide a request to analyze the digital content determining one or more unintended interpretations of digital content. User device 105 may include a communication device and a computing device. For example, user device 105 may include a wireless communication device, a mobile phone, a user equipment, a laptop computer, a tablet computer, a desktop computer, or a similar type of device.

Collaborative analysis system 110 may include one or more devices configured to analyze digital content to determine one or more unintended interpretations of the digital content, as explained herein. As shown in FIG. 1A, collaborative analysis system 110 may include the first components, such as an image recognition component 115, an NLP component 120, a layout component 125, and/or a semiotic component 130, among other examples.

In some implementations, image recognition component 115 may be configured to analyze the digital content using one or more object recognition algorithms. For example, image recognition component 115 may be configured to analyze the digital content to detect items identified by the digital content and/or positions of the items identified in the digital content. The one or more object recognition algorithms may include one or more machine learning models, such as a deep learning algorithm, a convolutional neural network (CNN), a Single Shot Detector (SSD) algorithm, and/or a You Only Look Once (YOLO) algorithm, among other examples.

In some implementations, image recognition component 115 may be configured to analyze the digital content using one or more speech recognition algorithms. For example, image recognition component 115 may be configured to analyze the digital content to generate text based on audio data included in the digital content. The one or more object recognition algorithms may include one or more machine learning models, such as a deep learning algorithm and/or a neural network, among other examples. Additionally, or alternatively, the one or more speech recognition algorithms may include hidden Markov models, a speaker diarization algorithm, among other examples.

NLP component 120 may be configured to analyze the digital content and/or information generated by image recognition component 115 using one or more NLP algorithms. For example, NLP component 120 may be configured to analyze the digital content and/or information generated by image recognition component 115 to determine a meaning of text (e.g., words) identified by the digital content, a concept associated with the text, a relationship between different portions of the text (e.g., a relationship between the words).

Layout component 125 may be configured to analyze the digital content and/or information generated by image recognition component 115 and/or generated by layout component 125 using a machine learning model trained to determine associations and oppositions based on the items and positions of the items. As an example, the machine learning model of layout component 125 may be trained using historical data identifying different items, identifying different positions of the different items, identifying different spatial layouts of the different items, and/or identifying items that are associated with each other (e.g. part of a group) and information identifying items that are not associated with each other.

Semiotic component 130 may be configured to analyze the digital content and/or information (generated by image recognition component 115) using a machine learning model trained to determine semiotic meanings associated with the items identified by the digital content. For example, semiotic component 130 may be configured to determine a meaning of a sign, a symbol, a logo, a gesture, among other examples. The machine learning model of semiotic component 130 may be trained using data identifying different items (e.g., signs, symbols, logos, and/or gestures) and data identifying meanings of each item and/or of a combination of the items.

As shown in FIG. 1A, collaborative analysis system 110 may include the one or more second components, such as a polysemy component 135. Polysemy component 135 may be configured to analyze information generated by image recognition component 115, NLP component 120, layout component 125, and/or semiotic component 130 and determine (or identify) unintended interpretations associated with the digital content based on analyzing the information generated by image recognition component 115, NLP component 120, layout component 125, and/or semiotic component 130. Polysemy component 135 may analyze the information using a machine learning model trained to determine unintended interpretations associated with the digital content. Polysemy component 135 may determine unintended interpretations using items and a combination of different types of items (e.g., a combination of words, concepts, objects, individuals, animals, among other examples).

The machine learning model of polysemy component 135 may be trained using historical data that includes data regarding items associated with historical events, data regarding items associated with cultural events, data regarding items associated with social events, and/or data regarding interpretations of items in different languages, among other examples. The machine learning model may generate, as an output, information identifying implicit meanings of the items. The implicit meanings may be based on a particular historical significance, a particular cultural significance, a particular social significance. The implicit meaning may be an unintended interpretation.

In some implementations, the historical data may be updated based on updated data regarding new historical events, new cultural events, new social events, among other examples. In some examples, collaborative analysis system 110 may implement a process that monitors news platforms and/or social media platforms to obtain the updated data.

While collaborative analysis system 110 has been described with respect to particular components, in some implementations, collaborative analysis system 110 may include additional or fewer components.

Knowledge base data structure 140 may include a database, a table, a queue, and/or a linked list that stores different digital content and information regarding the different content. For example, particular digital content may be stored in association with information regarding the particular digital content. In some instances, a component of collaborative analysis system 110 may obtain the particular digital content and/or the information regarding the particular content for analysis. The component may generate additional information regarding the particular content based on analyzing the particular digital content and/or the information regarding the particular content. The additional information may be stored, knowledge base data structure 140, in association with the particular digital content and/or the information regarding the particular content.

As shown in FIG. 1B, and by reference number 145, collaborative analysis system 110 may receive a request to analyze the digital content. Collaborative analysis system 110 may receive the request from user device 105. In some examples, the request may include information identifying the digital content and information identifying an intended meaning of the digital content. In some instances, the request may include the digital content. Alternatively, based on receiving the request, collaborative analysis system 110 may obtain the digital content from knowledge base data structure 140 using the information identifying the digital content. In this regard, the digital content may have been stored in knowledge base data structure 140 prior to collaborative analysis system 110 receiving the request.

In some instances, collaborative analysis system 110 may obtain (e.g., from user device 105 and/or knowledge base data structure 140) content type information identifying a type of the digital content and source information identifying a source of the digital content. As an example, the content type information may indicate that the digital content is an image, a video, or an audio. As another example, the source information may include a uniform resource identifier of the digital content (e.g., a uniform resource locator).

As shown in FIG. 1C, and by reference number 150, collaborative analysis system 110 may analyze the digital content using image recognition component 115. In some examples, collaborative analysis system 110 may analyze the digital content using the one or more object recognition algorithms of image recognition component 115 and/or using the one or more speech recognition algorithms of image recognition component 115.

As an example, the content type information may indicate that the digital content includes image data of the image. Additionally, or alternatively, the content type information may indicate that the digital content includes video data of the video (e.g., data of one or more frames of the video). Based on the content type information indicating the digital content includes the image data and/or the video data, image recognition component 115 may analyze the digital content using the one or more object recognition algorithms.

Based on analyzing the digital content using the one or more object recognition algorithms, image recognition component 115 may detect items identified by the digital content and positions of the items. The items may include an object, text, and/or an animal, among other examples. In some examples, based on the content type information indicating that the digital content includes the audio data, image recognition component 115 may analyze the digital content using the one or more speech recognition algorithms. Based on analyzing the digital content using the one or more speech recognition algorithms, image recognition component 115 may generate text from the audio data. In some implementations, collaborative analysis system 110 may include a separate component configured to perform speech-to-text functions. Image recognition component 115 may generate a first type of information based on analyzing the digital content.

As shown in FIG. 1C, and by reference number 155, collaborative analysis system 110 may store the first type of information generated by image recognition component 115. For example, collaborative analysis system 110 may store the first type of information in knowledge base data structure 140. The first type of information may be stored in association with information identifying the digital content. In some implementations, the first type of information may be a data element that includes information regarding the items identified by image recognition component 115 (e.g., using object recognition and/or speech recognition). As an example, the information regarding an item may include item type information identifying a type of the item, item information identifying the item, and position information identifying a position of the item in the digital content.

The item type information may indicate that the item is an image element, a word, and/or a text block, among other examples. The item information may indicate a name of the item, a title of the item, a description of the item, an identifier of the item, among other examples. The position information may indicate that the item is located in a top portion of the digital content, a bottom portion of the digital content, among other examples.

In some implementations, the first type of information of the item may further include information identifying a weight associated with the item. For example, the first type of information of the item may include information identifying a measure of confidence associated with image recognition component 115 identifying the item (e.g., using object recognition and/or speech recognition).

As shown in FIG. 1C, and by reference number 160, collaborative analysis system 110 may determine whether to analyze the first type of information using NLP component 120. For example, collaborative analysis system 110 (or NLP component 120) may determine that the digital content is to be analyzed by NLP component 120. In this regard, collaborative analysis system 110 (or NLP component 120) may determine whether knowledge base data structure 140 includes any information that may be analyzed as part of analyzing the digital content. For example, collaborative analysis system 110 (or NLP component 120) may determine whether knowledge base data structure 140 includes information identifying text provided by the digital content. For instance, collaborative analysis system 110 (or NLP component 120) may determine whether the first type of information identifies text that were provided by the digital content.

In some instances, collaborative analysis system 110 (or NLP component 120) may determine that the first type of information identifies text based on the item type information included in the first type of information. For example, the item type information of an item may indicate that the item is a word or a text block. Based on determining that the first type of information identifies text, collaborative analysis system 110 may determine that the first type of information is to be analyzed using NLP component 120, as part of analyzing the digital content. For example, NLP component 120 may analyze text provided by the digital content.

NLP component 120 may analyze the text using the one or more NLP algorithms. For example, NLP component 120 may analyze the text to determine a meaning of the text (e.g., words), to determine a concept associated with the text, to determine a relationship between different portions of the text (e.g., a relationship between the words), to determine an opinion conveyed by the text, among other examples. NLP component 120 may generate a second type of information based on analyzing the first type of information.

As shown in FIG. 1C, and by reference number 165, collaborative analysis system 110 may store the second type of information generated by NLP component 120. For example, collaborative analysis system 110 may store the second type of information in knowledge base data structure 140. The second type of information may be stored in association with information identifying the digital content and in association with the first type of information. In some implementations, the second type of information may be a data element that includes information regarding the meaning, the concept, and/or the relationship, among other examples.

As an example, the information regarding the relationship between words may include information indicating the relationship, relationship type information identifying a type of relationship, information identifying the words, among other examples. The relationship type information may indicate the relationship is an opposition or an association.

In some implementations, the second type of information may further include information identifying a weight associated with the relationship. For example, the second type of information may include information identifying a measure of confidence associated with NLP component 120 identifying the relationship.

As shown in FIG. 1D, and by reference number 170, collaborative analysis system 110 may determine whether to analyze the first type of information and/or the second type of information using layout component 125. For example, collaborative analysis system 110 (or layout component 125) may determine that the digital content is to be analyzed by layout component 125. In this regard, collaborative analysis system 110 (or layout component 125) may determine whether knowledge base data structure 140 includes any information that may be analyzed as part of analyzing the digital content. For example, collaborative analysis system 110 (or layout component 125) may determine whether knowledge base data structure 140 includes information identifying the items provided by the digital content and information identifying the positions of the items. For instance, collaborative analysis system 110 (or layout component 125) may determine whether the first type of information and/or the second type of information identify the items provided by the digital content and the positions of the items.

In some instances, collaborative analysis system 110 (or layout component 125) may determine that the first type of information identifies the items and the positions of the items based on the information identifying the items and the position information included in the first type of information. Collaborative analysis system 110 may determine the second type of information does not identify the positions of the items. Based on determining that the first type of information identifies the items and the positions of the items, collaborative analysis system 110 may determine that the first type of information is to be analyzed using layout component 125, as part of analyzing the digital content. For example, layout component 125 may analyze the positions of the items. Conversely, based on determining that the second type of information does not identify the items and the positions of the items, collaborative analysis system 110 may determine that the second type of information is not to be analyzed using layout component 125.

Layout component 125 may analyze the positions of the items to determine a spatial layout of the items. For example, layout component 125 may analyze the positions of the items to determine associations between the items and/or oppositions between the items based on the spatial layout (e.g., geometric associations between the items and/or geometric oppositions between the items).

For example, layout component 125 may determine that a first group of items and a second group of items. Layout component 125 may determine that items, of the first group, are positioned with a distance threshold of each other. Accordingly, layout component 125 may determine that the items of the first group are associated with each other. Layout component 125 may perform similar actions with respect to the items of the second group. Additionally, layout component 125 may determine that the first group and the second group are separated by a distance that satisfies the threshold distance. Accordingly, layout component 125 may determine that the first group is not associated with the second group. Layout component 125 may generate a third type of information based on analyzing the first type of information.

As shown in FIG. 1D, and by reference number 175, collaborative analysis system 110 may store the third type of information generated by layout component 125. For example, collaborative analysis system 110 may store the third type of information in knowledge base data structure 140. The third type of information may be stored in association with information identifying the digital content, the first type of information, and the second type of information. In some implementations, the third type of information may be a data element that includes information regarding the associations and/or the oppositions.

As an example, the information regarding the first group of items may include information indicating that the items (of the first group) are part of the first group, information identifying the items of the first group, and/or information identifying the first group, among other examples.

In some implementations, the third type of information may further include information identifying a weight associated with the association determined by layout component 125. For example, the third type of information may include information identifying a measure of confidence associated with layout component 125 identifying the association (e.g., identifying the first group).

Collaborative analysis system 110 may perform similar actions with respect to other components of the first components. For example, semiotic component 130 may determine whether to analyze the digital content using information generated by image recognition component 115, NLP component 120, and/or layout component 125. Semiotic component 130 may analyze the digital content using the information generated by image recognition component 115, NLP component 120, and/or and may store, in knowledge base data structure 140, information generated based on analyzing the digital component (e.g., semiotic meanings of items identified in the digital content). In some examples, a component may determine an inference between the information generated by image recognition component 115, NLP component 120, and/or layout component 125. For example, if NLP component 120 determine that a first item (e.g., a first word) and a second item (e.g., a second word) are opposite and if layout component 125 determines that the first items is included in the first group and that the second item is included in the second group, the component may determine that the first group and the second group opposed one with respect to another.

As shown in FIG. 1D, and by reference number 180, collaborative analysis system 110 may obtain the different types of information. For example, collaborative analysis system 110 may determine whether the first components have analyzed the digital content and have stored, in knowledge base data structure 140, information generated based on analyzing the digital content. Based on determining that the first components have analyzed the digital content and have stored the information, collaborative analysis system 110 may obtain the different types of information from knowledge base data structure 140.

In some implementations, collaborative analysis system 110 may obtain the different types of information based on the measures of confidence of the different types of information. For example, collaborative analysis system 110 may obtain a type of information based on determining that a measure of confidence, of the type of information, satisfies a confidence threshold.

As shown in FIG. 1D, and by reference number 185, collaborative analysis system 110 may analyze the different types of information using polysemy component 135. For example, polysemy component 135 may analyze the different types of information to determine implicit meanings and/or alternative meanings associated with the different types of information. For example, polysemy component 135 may determine implicit meanings associated with the objects, implicit meanings associated with the words, implicit meanings associated with the concept associated with the words, implicit meanings associated with the relationship between the words, implicit meanings associated with the groups of items, implicit meanings associated with the opinions, the semiotic meanings of the objects, and/or alternative meanings of the words in different languages, among other examples.

Polysemy component 135 may determine the implicit meanings and/or the alternative meanings based on the historical events, the cultural events, the social events, and/or among other examples. Polysemy component 135 may determine whether the implicit meanings or the alternative meanings are unintended interpretations.

As shown in FIG. 1E, and by reference number 190, collaborative analysis system 110 may determine unintended interpretations based on analyzing the different types of information. For example, polysemy component 135 may compare the intended interpretation (e.g., received via the request from user device 105) and the implicit meanings and/or the alternative meanings. Polysemy component 135 may determine that the implicit meanings and/or the alternative meanings are unintended interpretations based on determining that the intended meaning is different than the implicit meanings and/or the alternative meanings.

In some implementations, polysemy component 135 may determine one or more measures of confidence of one or more of the unintended interpretations. For example, if an unintended interpretation is determined based on or more types of information, polysemy component 135 may determine the measure of confidence of an unintended interpretation based on the one or more measures of confidence of the one or more types of information. For example, polysemy component 135 may determine the measure of confidence of an unintended interpretation based on a mathematical combination of the one or more measures of confidence.

In some implementations, polysemy component 135 may determine a category for one or more of the unintended interpretations. For example, the category of an unintended interpretation may include culturally insensitive, socially insensitive, age inappropriate, socially outdated, among other examples.

As shown in FIG. 1E, and by reference number 195, collaborative analysis system 110 may perform an action based on determining the unintended interpretations. In some implementations, collaborative analysis system 110 may aggregate information regarding the unintended interpretations. For example, the unintended interpretations may be organized based on the categories associated with the unintended interpretations. In some instances, the categories may be ranked based on a quantity of unintended interpretations included in each category.

In some implementations, collaborative analysis system 110 may provide information regarding the unintended interpretations. As an example, the unintended interpretations may provide (e.g., to user device 105) the unintended interpretations based on the categories. In some examples, collaborative analysis system 110 generate a dependency graph based on the different types of information.

In some implementations, collaborative analysis system 110 may determine modifications to the digital content to prevent any unintended interpretation or to reduce a possibility of an unintended interpretation. The modifications may include removing one or more words, adding one or more words, adding one or more objects, modifying text to modify the concept, removing one or more objects, modifying the spatial layout of one or more items, among other examples. Collaborative analysis system 110 may provide (e.g., to user device 105) information identifying the modifications.

In some implementations, collaborative analysis system 110 may modify the digital content to generate modified digital content. As an example, collaborative analysis system 110 may modify the digital content based on the modifications discussed above. In this regard, collaborative analysis system 110 may provide (e.g., to user device 105) the modified digital content and the information identifying the modifications.

An advantage of determining the one or more unintended interpretations prior to the digital content being provided to the user devices (e.g., for visual output and/or for audio output) is that the collaborative analysis system may preserve computing resources, network resources, and/or storage resources, among other examples, in order to delete the digital content, to provide the notifications to the other devices, and/or to reconfigure the other devices, among other examples.

As indicated above, FIGS. 1A-1E are provided as an example. Other examples may differ from what is described with regard to FIGS. 1A-1E. The number and arrangement of devices shown in FIGS. 1A-1E are provided as an example. A network, formed by the devices shown in FIGS. 1A-1E may be part of a network that comprises various configurations and uses various protocols including local Ethernet networks, private networks using communication protocols proprietary to one or more companies, cellular and wireless networks (e.g., Wi-Fi), instant messaging, hypertext transfer protocol (HTTP) and simple mail transfer protocol (SMTP, and various combinations of the foregoing.

There may be additional devices (e.g., a large number of devices), fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

FIG. 2 is a diagram of an example environment 200 in which systems and/or methods described herein can be implemented. As shown in FIG. 2, environment 200 may include collaborative analysis system 110, user device 105, and knowledge base data structure 140. Collaborative analysis system 110, user device 105, and knowledge base data structure 140 have been described above in connection with FIG. 1. Devices of environment 200 can interconnect via wired connections, wireless connections, or a combination of wired and wireless connections.

Collaborative analysis system 110 may include a communication device and a computing device. For example, collaborative analysis system 110 includes computing hardware used in a cloud computing environment. In some examples, collaborative analysis system 110 may include a server, such as an application server, a client server, a web server, a database server, a host server, a proxy server, a virtual server (e.g., executing on computing hardware), or a server in a cloud computing system.

Network 210 includes one or more wired and/or wireless networks. For example, network 210 may include Ethernet switches. Additionally, or alternatively, network 210 may include a cellular network, a public land mobile network (PLMN), a local area network (LAN), a wide area network (WAN), a private network, the Internet, and/or a combination of these or other types of networks. Network 210 enables communication between collaborative analysis system 110, user device 105, and knowledge base data structure 140.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

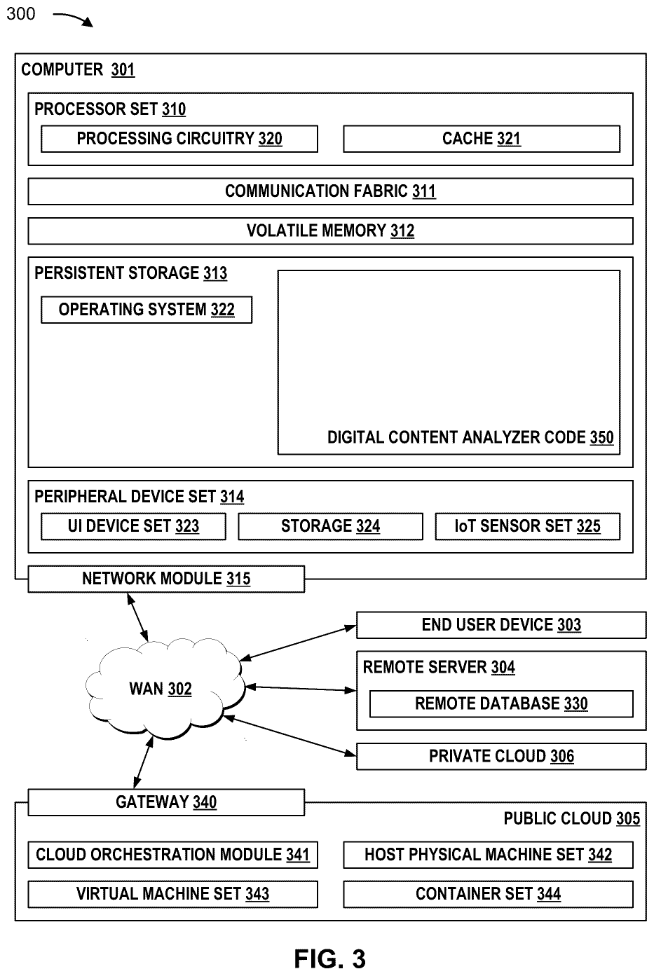

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as new digital content analyzer code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 1. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

FIG. 4 is a diagram of example components of a device 400, which may correspond to collaborative analysis system 110, user device 105, and/or knowledge base data structure 140. In some implementations, collaborative analysis system 110, user device 105, and/or knowledge base data structure 140 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

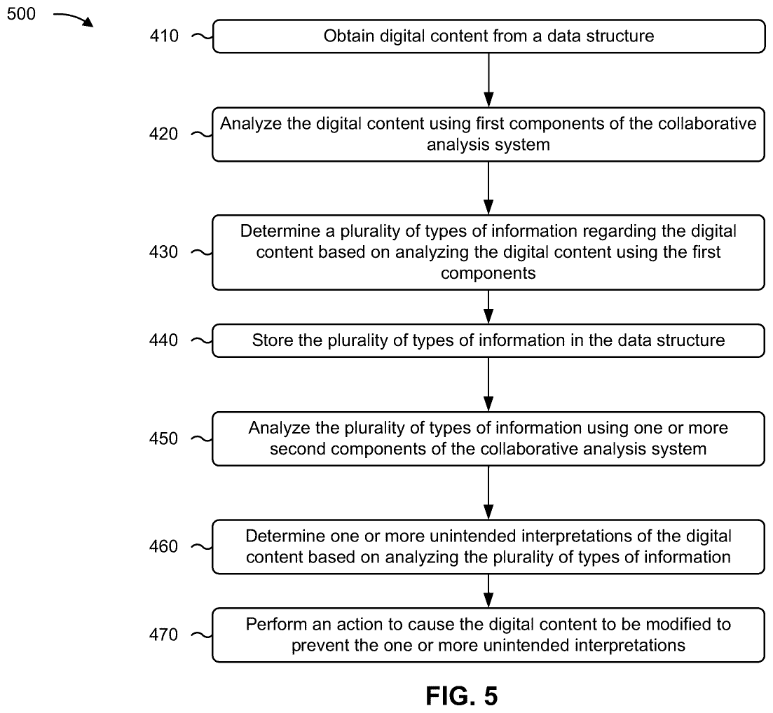

FIG. 5 is a flowchart of an example process 500 relating to analyzing digital content to determine unintended interpretation. In some implementations, one or more process blocks of FIG. 5 may be performed by a collaborative analysis system 110 (e.g., collaborative analysis system 110). In some implementations, one or more process blocks of FIG. 5 may be performed by another device or a group of devices separate from or including the data center management system, such as a user device (e.g., user device 105). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining digital content from a data structure (block 510). For example, the collaborative analysis system may obtain digital content from a data structure, as described above.

As further shown in FIG. 5, process 500 may include analyzing the digital content using first components of the collaborative analysis system (block 520). For example, the collaborative analysis system may analyze the digital content using first components of the collaborative analysis system. Each component, of the first components, utilizes a respective machine learning model to analyze the digital content, as described above. In some implementations, each component, of the first components, utilizes a respective machine learning model to analyze the digital content.

As further shown in FIG. 5, process 500 may include determining a plurality of types of information regarding the digital content based on analyzing the digital content using the first components (block 530). For example, the collaborative analysis system may determine a plurality of types of information regarding the digital content based on analyzing the digital content using the first components, as described above.

As further shown in FIG. 5, process 500 may include storing the plurality of types of information in the data structure (block 540). For example, the collaborative analysis system may store the plurality of types of information in the data structure, as described above.

As further shown in FIG. 5, process 500 may include analyzing the plurality of types of information using one or more second components of the collaborative analysis system (block 550). For example, the collaborative analysis system may analyze the plurality of types of information using one or more second components of the collaborative analysis system. Each component, of the one or more second components, utilizes a respective machine learning model to analyze the plurality of types, as described above. In some implementations, each component, of the one or more second components, utilizes a respective machine learning model to analyze the plurality of types.

As further shown in FIG. 5, process 500 may include determining one or more unintended interpretations of the digital content based on analyzing the plurality of types of information (block 560). For example, the collaborative analysis system may determine one or more unintended interpretations of the digital content based on analyzing the plurality of types of information, as described above.

As further shown in FIG. 5, process 500 may include performing an action to cause the digital content to be modified to prevent the one or more unintended interpretations (block 570). For example, the collaborative analysis system may perform an action to cause the digital content to be modified to prevent the one or more unintended interpretations, as described above.

In some implementations, determining the plurality of types of information comprises determining a weight of each type of information of the plurality of types of information. The weight of a type of information indicates a measure of confidence associated with the type of information. Determining the one or more unintended interpretations comprises determining one or more weights of the one or more unintended interpretations based on the weight determined for each type of information of the plurality of types of information.

In some implementations, performing the action comprises providing information identifying the one or more unintended interpretations and information identifying the one or more weights of the one or more unintended interpretations.

In some implementations, analyzing the digital content comprises determining whether to analyze the digital content using one or more types of information of the plurality of types of information, analyzing the digital content using the one or more types of information based on determining to analyze the digital content using one or more types of information, and generating by the component, an additional type of information based on analyzing the digital content using the one or more types of information.

In some implementations, obtaining the digital content comprises obtaining image data of an image. The first components include a image recognition component. Determining the plurality of types of information comprises determining, using the image recognition component, a type of information that identifies one or more items detected in the image data and positions of the one or more items in the image data.

In some implementations, the type of information is a first type of information. The one or more items includes words, the first components further include a natural language processing (NLP) component, and determining the plurality of types of information comprises analyzing, using the NLP component, the first type of information, and determining, using the NLP component, a second type of information that identifies a meaning associated with the words identified by the image recognition component based on analyzing the first type of information.

In some implementations, the first components further include a layout component. Determining the plurality of types of information comprises analyzing, using the layout component, information from a group consisting of the first type of information and the second type of information, and determining, using the layout component, a third type of information that identifies a spatial layout of the image data. The spatial layout identifies one or more groups of the items identified by the first type of information.

In some implementations, analyzing the plurality of types of information comprise performing a linguistic analysis of information identified by one or more types of information of the plurality of information; and determining a semantic meaning of a concept associated with the information identified by the one or more types of information. The unintended interpretation may be based on the semantic meaning.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method performed by a collaborative analysis system, the computer-implemented method comprising:
obtaining digital content from a data structure;
analyzing the digital content using first components of the collaborative analysis system,
wherein each component, of the first components, utilizes a respective machine learning model to analyze the digital content;
determining a plurality of types of information regarding the digital content based on analyzing the digital content using the first components;
storing the plurality of types of information in the data structure;
analyzing the plurality of types of information using a second component of the collaborative analysis system,
wherein the second component utilizes a respective machine learning model to analyze the plurality of types of information;
determining one or more unintended interpretations of the digital content based on analyzing the plurality of types of information; and
performing an action to cause the digital content to be modified to prevent the one or more unintended interpretations.

2. The computer-implemented method of claim 1, wherein determining the plurality of types of information comprises:
determining a weight of each type of information of the plurality of types of information,
wherein the weight of a type of information indicates a measure of confidence associated with the type of information, and
wherein determining the one or more unintended interpretations comprises:
determining one or more weights of the one or more unintended interpretations based on the weight determined for each type of information of the plurality of types of information.

3. The computer-implemented method of claim 2, wherein performing the action comprises:
providing information identifying the one or more unintended interpretations and information identifying the one or more weights of the one or more unintended interpretations.

4. The computer-implemented method of claim 1, wherein analyzing the digital content comprises:
determining, by a component of the first components, whether to analyze the digital content using one or more types of information of the plurality of types of information;
analyzing, by the component, the digital content using the one or more types of information based on determining to analyze the digital content using one or more types of information; and
generating, by the component, an additional type of information based on analyzing, by the component, the digital content using the one or more types of information.

5. The computer-implemented method of claim 1, wherein obtaining the digital content comprises:
obtaining image data of an image,
wherein the first components include an image recognition component, and
wherein determining the plurality of types of information comprises:
determining, using the image recognition component, a type of information that identifies one or more items detected in the image data and positions of the one or more items in the image data.

6. The computer-implemented method of claim 5, wherein the type of information is a first type of information,
wherein the one or more items includes words,
wherein the first components further include a natural language processing (NLP) component, and
wherein determining the plurality of types of information comprises:
analyzing, using the NLP component, the first type of information; and
determining, using the NLP component, a second type of information that identifies a meaning associated with the words identified by the image recognition component based on analyzing the first type of information.

7. The computer-implemented method of claim 6, wherein the first components further include a layout component, and
wherein determining the plurality of types of information comprises:
analyzing, using the layout component, information from a group consisting of the first type of information and the second type of information; and
determining, using the layout component, a third type of information that identifies a spatial layout of the image data,
wherein the spatial layout identifies one or more groups of the items identified by the first type of information.

8. A computer program product for determining unintended interpretations of content, the computer program product comprising:
one or more computer readable storage media, and program instructions collectively stored on the one or more computer readable storage media, the program instructions comprising:
program instructions to analyze digital content using first components of a collaborative analysis system;
program instructions to determine a plurality of types of information regarding the digital content based on analyzing the digital content using the first components;
program instructions to analyze the plurality of types of information using a second component of the collaborative analysis system;
program instructions to determine one or more unintended interpretations of the digital content based on analyzing the plurality of types of information; and
program instructions to provide information regarding the one or more unintended interpretations to a device.

9. The computer program product of claim 8, wherein the program instructions to determine the one or more unintended interpretations comprise:
program instructions to analyze information identified by one or more types of information of the plurality of types of information; and
program instructions to determine an unintended interpretation based on analyzing the information identified by the one or more types of information.

10. The computer program product of claim 8, wherein the first components include a semiotic component, and
wherein the program instructions to determine the plurality of types of information comprise:
program instructions to analyze, using the semiotic component, objects identified by one or more of the plurality of types of information; and
program instructions to determine a semiotic meaning of the objects,
wherein the plurality of types of information includes a type of information identifying the semiotic meaning.

11. The computer program product of claim 9, wherein the program instructions further comprise
program instructions to obtain the digital content from a knowledge base; and
program instructions to store the plurality of types of information in the knowledge base,
wherein the plurality of types of information, analyzed using the second component, are obtained from the knowledge base.

12. The computer program product of claim 8, wherein the first components include an image recognition component, and
wherein the program instructions to determine the plurality of types of information comprise:
program instructions to determine a type of information regarding items identified by the digital content.

13. The computer program product of claim 12, wherein the first components include a layout component, and
wherein the program instructions to determine the plurality of types of information comprises:
program instructions to determine a type of information that identifies geometric associations between the items identified by the digital content or geometric oppositions between the items identified by the digital content.

14. The computer program product of claim 8, wherein the program instructions to analyze the plurality of types of information comprise:
program instructions to perform a linguistic analysis of information identified by one or more types of information of the plurality of information; and
program instructions to determine a semantic meaning of a concept associated with the information identified by the one or more types of information,
wherein the unintended interpretation is based on the semantic meaning.

15. A system comprising:
one or more devices configured to:
analyze information regarding digital content using first components of the system;
determine a plurality of types of information regarding the digital content based on analyzing the information regarding the digital content using the first components;
analyze the plurality of types of information using a second component of the system;
determine one or more unintended interpretations of the digital content based on analyzing the plurality of types of information; and
provide information regarding the one or more unintended interpretations to a device.

16. The system of claim 15, wherein, to analyze the digital content, the one or more devices are configured to:
analyze, using a first one of the first components of the system, the digital content; and
analyze, using a second one of the first components of the system, the digital content and information generated based on the first one of the first components analyzing the digital content.

17. The system of claim 15, wherein the one or more unintended interpretations are a plurality of unintended interpretations, and
wherein the one or more devices are configured to:
aggregate the plurality of unintended interpretations into a first group of unintended interpretations and a second group of unintended interpretations; and
provide first information regarding first group of unintended interpretations and second information regarding the second group of unintended interpretations.

18. The system of claim 17, wherein, to provide the first information, the one or more devices are configured:
determine that a measure of confidence, associated with the first group of unintended interpretations, satisfies a confidence threshold; and
provide the first information based on determining that the measure of confidence satisfies the confidence threshold.

19. The system of claim 17, wherein, to provide the first information, the one or more devices are configured:
determine a first measure of confidence associated with the first group of unintended interpretations;
determine a second measure of confidence associated with the second group of unintended interpretations;
rank the first information and the second information based on the first measure of confidence and the second measure of confidence; and
provide the first information and the second information based on ranking the first information and the second information.

20. The system of claim 15, wherein, to determine the plurality of types of information, the one or more devices are configured:
determine a first type of information that identifies one or more items detected in the digital content, and
determine a second type of information that identifies a relationship between two or more words included in the digital content; and
wherein, to determine one or more unintended interpretations, the one or more devices are configured:
determine one or more unintended interpretations based on the one or more items or the two or more words.
